(19) United States
(12) Patent Application Publication
(10) Pub. No.: US 2005/0271044 A1
(43) Pub. Date: Dec. 8, 2005

(54) Method for managing a stack of switches

(75) Inventors: Chuan-Cheng Hsu, Tu-Cheng (TW); I-Chiung Weng, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/070,794

(22) Filed: Mar. 2, 2005

(30) Foreign Application Priority Data
Jun. 3, 2004 (CN) 200410026469.9

(51) Int. Cl. H04L 12/28

(52) U.S. Cl. 370/360

(57) ABSTRACT

A method for managing a stack (1) of switches (10, 20, 30, 40) includes the steps of: constructing a stack comprising a plurality of stackable switches according to a desired topology; sending a packet comprising information on topology and priority from each switch to a neighboring switch in order to record the topology of the sending switch; electing a master switch (10) according to media access control addresses and priorities of the switches; configuring slave switches (20, 30, 40) remotely through the master switch; and retrieving statistical data on the slave switches through the master switch; or retrieving status data on the slave switches through the master switch. Thus, users can conveniently manage all slave switches of the stack through the master switch.

### BACKGROUND OF THE INVENTION

1. Field of the Invention

The present invention relates to methods for managing switches in an electronic communication network, and particularly to a method for managing a stack of switches.

2. Prior Art

Stacking switches is the connecting of a plurality of switches together to form a stack, which can provide more ports than a single switch. The stack of switches can provide a connecting service for more users, and is suitable for forming a communication network. Stackable switches are being used more and more widely in enterprise networks and broadband networks due to their flexible expansibility. In actual implementation, the stack of switches needs to increase transmitting distances of signals, and all the switches therein need to be managed effectively. Generally, stackable interfaces and stacking cables are also needed to form an operable stack of switches. For example, China patent no. 1412974A entitled “Method for implementing stacking of Ethernet switches” and published on Apr. 23, 2003 provides a method for stacking of Ethernet switches. The method comprises: Giga parallel signals output by a first Ethernet switch being transformed to Giga serial signals by a transforming circuit; and the Giga serial signals being transmitted through cables to a second Ethernet switch that is to be stacked with the first Ethernet switch. When the first Ethernet switch receives Giga serial signals sent by the second Ethernet switch, the Giga serial signals are firstly transformed to Giga parallel signals by the transforming circuit, and are then sent to the first Ethernet switch.

Although the method can implement stacking, and can increase the transmitting distance of signals, it does not provide for managing or maintaining a stack of switches.

### SUMMARY OF THE INVENTION

An objective of the present invention is to provide a method for managing a stack of switches effectively.

In order to fulfill the above-mentioned objective, a method of the present invention for managing a stack of switches comprises the steps of: (a) constructing a stack comprising a plurality of stackable switches according to a desired topology; (b) sending a packet comprising information on topology and priority from each switch to a neighboring switch in order to record topology of the sending switch; (c) electing a master switch according to media access control addresses and priorities of the switches; (d) configuring slave switches remotely through the master switch; and (e) retrieving statistical data on the slave switches through the master switch; or (f) retrieving status data on the slave switches through the master switch. Thus, users can conveniently manage all slave switches of the stack through the master switch.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic diagram of an exemplary stack of switches according to the present invention;

FIG. 2 is a schematic diagram of internal modules of a master switch and one slave switch of the stack of FIG. 1;

FIG. 3 is a flow chart of remotely configuring one slave switch of the stack of FIG. 1, according to the present invention;

FIG. 4 is a flow chart of one slave switch of the stack of FIG. 1 reporting statistical data to the master switch of the stack, according to the present invention; and

FIG. 5 is a flow chart of one slave switch of the stack of FIG. 1 reporting status data to the master switch of the stack, according to the present invention.

### DETAILED DESCRIPTION OF THE INVENTION

Some terms employed in describing the present invention are explained as follows:

“Stack” is a logic representation of a group of switches that are physically connected together through appropriate connectors and cables.

“Master switch” is an elected switch from a stack of switches, which is configured for managing other switches in the stack.

“Slave switch” is a common name for a switch in a stack other than the master switch. A slave switch cannot be managed directly.

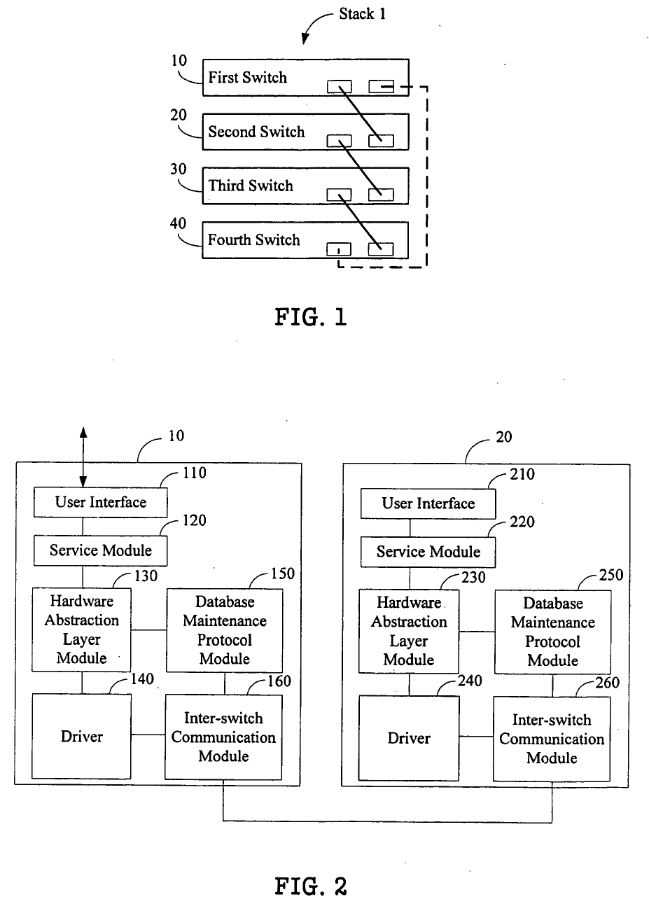

In a preferred embodiment of the present invention, a stack is formed by a plurality of switches that are connected together according to a certain topology. The topology may be a daisy chain topology, or a ring topology. The ring topology provides a redundant link to the stack. The number of switches in a stack ranges from two to more than ten. FIG. 1 is a schematic diagram of an exemplary stack 1 that comprises four switches 10, 20, 30, 40. Each of the switches 10, 20, 30, 40 in the stack 1 has two stacking ports: one for up-link connection, and the other for down-link connection. The switches 10, 20, 30, 40 connected by continuous lines in FIG. 1 form a daisy chain topology. When a line, such as the broken line in FIG. 1, is used to connect the first switch 10 and the last switch 40 in the stack 1, a ring topology is formed.

It is assumed that the first switch 10 is elected as the master switch, and that the other three switches 20, 30, 40 are slave switches. FIG. 2 is a schematic diagram of internal modules of the master switch 10 and the slave switch 20 according to the present invention. The slave switches 30, 40 have structures similar to that of the slave switch 20, and are not shown in FIG. 2. The master switch 10 comprises a user interface 110, a service module 120, a hardware abstraction layer module 130, a driver 140, a database maintenance protocol module 150, and an inter-switch communication module 160. The user interface 110 is provided for communication with a remote network manager (or any number of remote network managers). The service module 120 comprises a plurality of applications that can implement various functions of the master switch 10. The hardware abstraction layer module 130 is a virtual mapping of hardware components of the master switch 10, and is provided for supporting various programs and services in the master switch 10. The driver 140 drives various hardware components of the master switch 10. The database maintenance protocol module 150 is provided for storing data on the slave switches 20, 30, 40, and for constructing remote configuring commands. The inter-switch communication module 160 is used for communication of the master switch 10 with the slave switches 20, 30, 40.

The slave switch 20 has a structure similar to that of the master switch 10. For the sake of brevity, the slave switch 20 is not fully described in detail herein. Like reference numerals of components of the master switch 10 and the slave switch 20 indicate like components. The components of the slave switch 20 have functions similar to those of the corresponding components of the master switch 10, except for a user interface 210 and a maintenance protocol module 250 of the slave switch 20. Because the remote network manager cannot communicate with the slave switch 20 directly, the user interface 210 is not used. The maintenance protocol module 250 is used for constructing reports. The inter-switch communication module 160 of the master switch 10 is electronically connected to an inter-switch communication module 260 of the slave switch 20 for communicating with the slave switch 20. In the preferred embodiment, the remote network manager does not communicate with the slave switch 20 via the user interface 210. However, if the slave switch 20 is elected to be the master switch, the remote network manager communicates with the switch 20 through the user interface 210 instead of through the user interface 110.

A method for managing the stack 1 comprises the following steps:

1. Constructing the Stack 1

Before constructing the stack 1, all the switches 10, 20, 30, 40 in the stack 1 must be powered off, otherwise the stack 1 may not be constructed successfully. Then a stack cable is employed to connect an up-link port of each switch to a down-link port of another switch. In this way, for any two switches, there is only one link between them. After being properly configured, the stack 1 forms a daisy chain topology or a ring topology. Once the stack 1 is constructed, the switches 10, 20, 30, 40 of the stack 1 can be powered on.

2. Recording the Topology

There are topology recording functions in CPUs of the switches 10, 20, 30, 40 in the stack 1. As soon as the stack 1 is constructed, and the switches 10, 20, 30, 40 are powered on, each of the CPUs sends an introductory packet to its neighboring CPU. The introductory packet comprises a MAC (Media Access Control) address, priority, topology, CPU number, and number of chips controlled by the CPU. When the neighboring CPU receives the introductory packet from the previous CPU, the neighboring CPU compares its MAC address and priority with those in the received introductory packet. If the priority of the neighboring CPU is higher, the neighboring CPU discards the received introductory packet. If the priority of the neighboring CPU is lower, the neighboring CPU appends the information in its introductory packet to the received introductory packet, sends the new introductory packet to a next neighboring CPU, and sends back the new introductory packet to the previous CPU. Thus, the topology of the stack 1 is recorded.

3. Electing the Master Switch

Logically, the master switch 10 represents the stack 1. The remote network manager can manage the slave switches 20, 30, 40 in the stack 1 indirectly according to the IP (Internet Protocol) address of the master switch 10. The master switch 10 can be assigned manually, or can be elected automatically according to an ordering criterion. The ordering criterion is based on attribute data on the switches 10, 20, 30, 40, such as their MAC addresses and priorities. Generally, the first switch in numerical order is the master switch. The ordering criterion can be embedded in the introductory packet of each CPU. Thus, the master switch can be elected during the procedure of recording the topology.

Once the master switch 10 is elected, all the other switches 20, 30, 40 are automatically slave switches. The master switch 10 communicates with the remote network manager through the user interface 110. The master switch 10 receives commands of the remote network manager through the user interface 110, and sends the commands to the slave switches 20, 30, 40 in the stack 1. After receiving the commands, the slave switches 20, 30, 40 send responses that correspond to the commands to the master switch 10. When any events occur in the slave switches 20, 30, 40, the slave switches 20, 30, 40 send event logs to the master switch 10.

If the master switch 10 is not working, a backup master switch becomes the new master switch. If there is no backup master switch, the slave switch that is the next in numerical order after the master switch 10 becomes the new master switch. That is, the slave switch 20 becomes the new master switch. Then all the switches 10, 20, 30, 40 are restarted up, and the topology recording procedure is restarted.

4. Managing the Stack

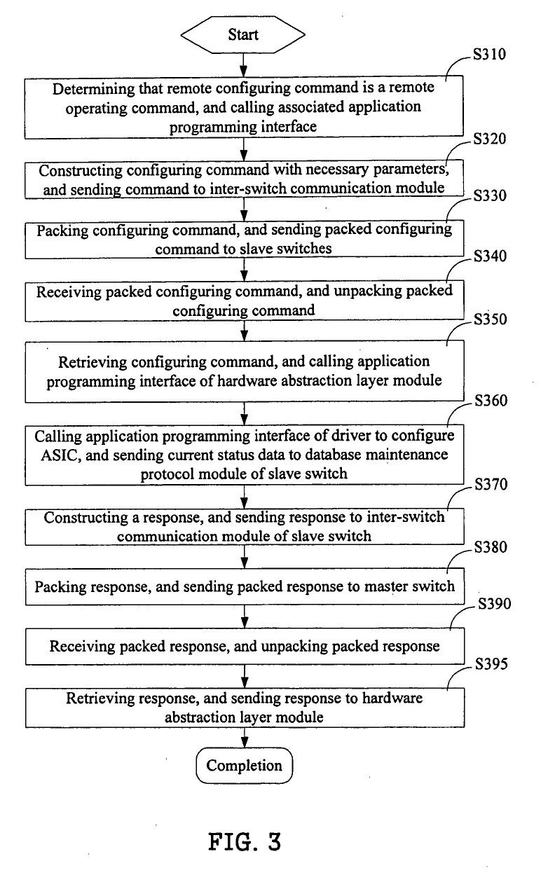

There are four management mechanisms to manage the stack 1 of switches 10, 20, 30, 40: RS232 (recommended standard-232) console access management, remote Telnet access management, remote web access management, and remote Simple Network Management Protocol (SNMP) access management. The RS232 console access management manages the stack 1 via a console that is connected to the master switch 10 through an RS232 connector. The other three methods manage the stack 1 remotely according to the IP address of the master switch 10. Direct remote management of the slave switches 20, 30, 40 is disabled for security reasons, and instead is implemented through the master switch 10. When the master switch 10 receives configuring commands from the remote network manager, the master switch 10 sends a packet comprising the configuring commands to the slave switches 20, 30, 40. More details of this process are described hereinbelow in relation to FIGS. 3 through 5.

In the preferred embodiment, in response to managing a request of the remote network manager, the master switch 10 retrieves data from the slave switches 20, 30, 40 or configures the slave switches 20, 30,40. For efficiency, the master switch 10 keeps a copy of respective databases of each of the slave switches 20, 30, 40, and uses data in the copy databases to respond to the managing request of the remote network manager. In this way, the stack 1 minimizes communications between the master switch 10 and the slave switches 20, 30, 40, and thus the response time is reduced.

Data stored in the database of the master switch 10 comprise configuration data, status data, and statistical data. The configuration data record configurations of the slave switches 20, 30, 40. The status data record operating statuses of the stack 1, such as status data on port links. The slave switches 20, 30, 40 report the status data to the master switch 10 periodically. The database maintenance protocol module 150 of the master switch 10 comprises a buffer (not shown) to store incoming reports. When the hardware abstraction layer module 130 needs to retrieve the status data on any of the slave switches 20, 30, 40, the hardware abstraction layer module 130 calls the database maintenance protocol module 150. The database maintenance protocol module 150 then sends the status data stored in the buffer to the hardware abstraction layer module 130.

The statistical data are information recorded by counters that are provided by the slave switches 20, 30, 40. It is not necessary for the statistical data to be updated periodically. However, for efficiency, a statistics cache is provided in the hardware abstraction layer module 130 of the master switch 10, to reduce communications between the master switch 10 and the slave switches 20, 30, 40. When receiving a first request for statistical data, the master switch 10 retrieves relevant statistical data, and stores the retrieved statistical data in the statistics cache. When receiving a subsequent request for statistical data, the master switch 10 first searches the statistics cache. If there are statistical data corresponding to the subsequent request in the statistics cache, the master switch 10 retrieves the corresponding statistical data from the statistics cache. If there are no statistical data corresponding to the subsequent request in the statistics cache, the master switch 10 accesses the relevant slave switches 20, 30, 40 to retrieve the corresponding statistical data, and stores the statistical data in the statistics cache. In addition, the master switch 10 configures a predetermined time period for each kind of statistical data that is stored in the statistics cache, to ensure that the validity of the statistical data is up to date. When the predetermined time period elapses, the validity of the statistical data expires, and the master switch 10 accesses the relevant slave switches 20, 30, 40 to update the statistical data.

FIG. 3 is a flow chart of remotely configuring the slave switch 20. In this remote configuration, the master switch 10 configures the slave switch 20 according to requirements of the remote network manager. The remote configuration is implemented by changing a configuration of an Application Specific Integrated Circuit (ASIC) of the slave switch 20. At step S310, when the master switch 10 receives a remote configuring command from the remote network manager through the user interface 110, the hardware abstraction layer module 130 determines that the remote configuring command is a remote operating command, and calls an associated Application Programming Interface (API) of the database maintenance protocol module 150. At step S320, the database maintenance protocol module 150 constructs the configuring command with necessary parameters, such as a port speed of the slave switch 20, and sends the command to the inter-switch communication module 160.

At step S330, the inter-switch communication module 160 packs the configuring command, and sends the packed configuring command to the slave switch 20. At step S340, the inter-switch communication module 260 receives the packed configuring command, and unpacks the packed configuring command. At step S350, the database maintenance protocol module 250 retrieves the unpacked configuring command, and calls an associated API of the hardware abstraction layer module 230. At step S360, the hardware abstraction layer module 230 calls an associated API of the driver 240 to configure the ASIC, and sends current status data to the database maintenance protocol module 250. At step S370, the database maintenance protocol module 250 constructs a response based on the current status data, and sends the response to the inter-switch communication module 260. At step S380, the inter-switch communication module 260 packs the response, and sends the packed response to the master switch 10. At step S390, the inter-switch module 160 receives the packed response, and unpacks the response. At step S395, the database maintenance protocol module 150 retrieves the response, and sends the response to the hardware abstraction layer module 130. Thus, the remote network manager finishes the remote configuration of the slave switch 20 through the master switch 10. Remote configurations of the slave switches 30, 40 are performed in much the same manner as the above-described remote configuration of the slave switch 20.

The hardware abstraction layer module 130 cannot proceed until the inter-switch communication module 160 returns the response. For a more reliable system, the inter-switch communication module 160 can have a timeout and retry mechanism. Thus if the inter-switch communication module 160 does not receive a packed response within a predetermined time, the inter-switch communication module 160 resends the packed configuring command. After predetermined number of retries without success, the inter-switch communication module 160 returns a failure message to the hardware abstraction layer module 130.

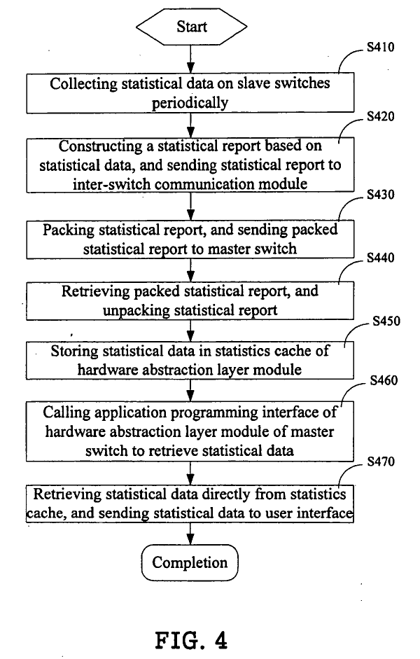

FIG. 4 is a flow chart of the slave switch 20 reporting statistical data to the master switch 10. Procedures for the slave switches 30, 40 reporting statistical data to the master switch 10 correspond to that of the slave switch 20. At step S410, the hardware abstraction layer module 230 of the slave switch 20 collects the statistical data on the slave switch 20 periodically. At step S420, the database maintenance protocol module 250 constructs a statistical report based on the statistical data, and sends the statistical report to the inter-switch communication module 260. At step S430, the inter-switch communication module 260 packs the statistical report, and sends the packed statistical report to the master switch 10. At step S440, the inter-switch communication module 160 retrieves the packed statistical report, and unpacks the packed statistical report to obtain the statistical data.

At step S450, the database maintenance protocol module 150 stores the statistical data in the statistics cache of the hardware abstraction layer module 130. At step S460, when the remote network manager wants to retrieves statistical data on the slave switch 20, the user interface 110 calls the API of the hardware abstraction layer module 130 to retrieve the statistical data. At step S470, the hardware abstraction layer module 130 retrieves the statistical data directly from the statistics cache of the hardware abstraction layer module 130, and sends the statistical data to the user interface 110.

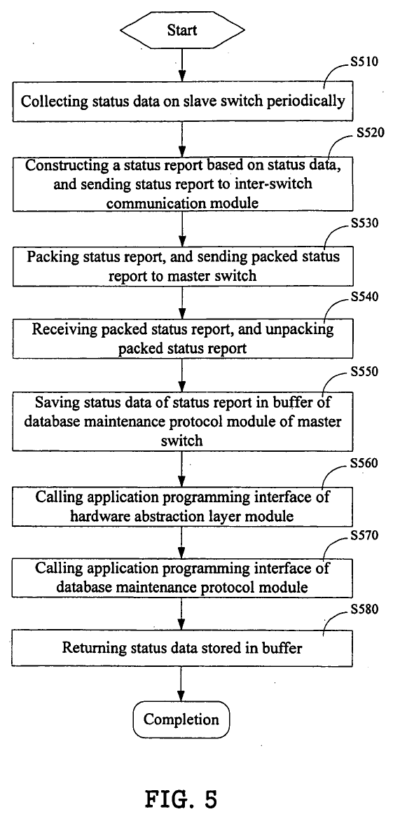

FIG. 5 is a flow chart of the slave switch 20 reporting status data to the master switch 10. Procedures for reporting status data to the master switch 10 from the slave switches 30, 40 correspond to that of the slave switch 20. At step S510, the hardware abstraction layer module 230 of the slave switch 20 collects the status data on the slave switch 20 periodically. At step S520, the database maintenance protocol module 250 constructs a status report based on the status data, and sends the status report to the inter-switch communication module 260. At step S530, the inter-switch communication module 260 packs the status report, and sends the packed status report to the master switch 10. At step S540, the inter-switch communication module 160 receives the packed status report, and unpacks the status report to obtain the status data. At step S550, the database maintenance protocol module 150 of the master switch 10 saves the status data in the buffer of the database maintenance protocol module 150. At step S560, the user interface 110 calls the API of the hardware abstraction layer module 130 to retrieve the status data periodically. At step S570, the hardware abstraction layer module 130 calls the API of the database maintenance protocol module 150. At step S580, the database maintenance protocol module 150 returns the status data stored in the buffer thereof.

It is believed that the present invention and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

1. A method for managing a stack of switches, comprising the steps of:
(a) constructing a stack comprising a plurality of stackable switches according to a desired topology;
(b) sending a packet comprising information on topology and priority from each switch to a neighboring switch in order to record the topology of the sending switch;
(c) electing a master switch according to media access control addresses and priorities of the switches;
(d) configuring slave switches remotely through the master switch; and
(e) retrieving statistical data on the slave switches through the master switch; or
(f) retrieving status data on the slave switches through the master switch.

2. The method as recited in claim 1, wherein step (a) comprises constructing the stack according to a daisy chain topology.

3. The method as recited in claim 1, wherein step (a) comprises constructing the stack according to a ring topology.

4. The method as recited in claim 1, wherein step (b) comprises the steps of:
(b1) the neighboring switch comparing its priority with a priority in the received packet; and
(b2) discarding the received packet, if the priority of the neighboring switch is higher than that of the sending switch; or
(b3) the neighboring switch appending its data on topology and priority to the received packet to form a new packet, and sending the new packet to a next neighboring switch and to the sending switch, if the priority of the neighboring switch is lower than that of the sending switch.

5. The method as recited in claim 1, wherein step (d) comprises the steps of:
(d1) calling an application programming interface of a database maintenance protocol module by a hardware abstraction layer module of the master switch, when the master switch receives remote configuring commands;
(d2) constructing the configuring commands, and sending the configuring commands to an inter-switch communication module of the master switch;
(d3) packing the configuring commands, and sending the packed configuring commands to the slave switches;
(d4) receiving the packed configuring commands, and unpacking the received configuring commands;
(d5) retrieving the configuring commands, and calling an application programming interface of a hardware abstraction layer module of each of the slave switches by a database maintenance protocol module of each of the slave switches; and
(d6) calling an application programming interface of a driver of each of the slave switches to configure an application specific integrated circuit, and sending current status data to the database maintenance protocol module of each of the slave switches.

6. The method as recited in claim 5, wherein step (d) further comprises the steps of:
(d7) constructing a response based on the current status data by the database maintenance protocol module of each of the slave switch;
(d8) packing the response, and sending the packed response to the master switch;
(d9) receiving the packed responses from all the slave switches, and unpacking the received responses; and
(d10) retrieving the responses, and sending the responses to the hardware abstraction layer module of the master switch.

7. The method as recited in claim 5, wherein step (d) further comprises the steps of resending the packed configuring commands, and returning a failure message to the hardware abstraction layer module of the master switch.

8. The method as recited in claim 1, wherein step (e) comprises the steps of:
(e1) collecting statistical data on each slave switch periodically by a hardware abstraction layer module of the slave switch;
(e2) constructing a statistical report based on the statistical data, and sending the statistical report to an inter-switch communication module of the slave switch;
(e3) packing the statistical report, and sending the packed statistical report to the master switch;
(e4) receiving the packed statistical reports from all the slave switches, and unpacking the received statistical reports; and
(e5) saving the statistical data in the statistical reports in a statistics cache of a hardware abstraction layer module of the master switch by a database maintenance protocol module of the master switch.

9. The method as recited in claim 8, wherein step (e) further comprises the steps of:
(e6) calling an application programming interface of the hardware abstraction layer module of the master switch to retrieve statistical data; and
(e7) retrieving the statistical data directly from the statistics cache, and sending the statistical data to a user interface of the master switch.

10. The method as recited in claim 1, wherein step (f) comprises the steps of:
(f1) collecting status data on each slave switch periodically by a hardware abstraction layer module of the slave switch;
(f2) constructing a status report based on the status data, and sending the status report to an inter-switch communication module of the slave switch;
(f3) packing the status report, and sending the packed status report to the master switch;
(f4) receiving the packed status reports from all the slave switches, and unpacking the received status reports; and
(f5) saving the status data in the status reports in a buffer of a database maintenance protocol module of the master switch.

11. The method as recited in claim 10, wherein step (f) further comprises the steps of:
(f6) calling an application programming interface of a hardware abstraction layer module of the master switch to retrieve status data;
(f7) calling an application programming interface of a database maintenance protocol module of the master switch; and
(f8) retrieving the status data stored in the buffer of the database maintenance protocol module of the master switch.

12. The method as recited in claim 1, further comprising the step of sending an event message to the master switch by any of the slave switches.

13. The method as recited in claim 1, wherein the slave switches are managed through a user interface of the master switch by remote Telnet access.

14. The method as recited in claim 1, wherein the slave switches are managed through a user interface of the master switch by remote web access.

15. The method as recited in claim 1, wherein the slave switches are managed through a user interface of the master switch by remote simple network management protocol access.

16. A method for managing a stack of switches, comprising the steps of:
constructing said stack of switches by means of connecting a plurality of stackable switches together according to a predetermined topology;
identifying one of said plurality of switches as a master switch and others of said plurality of switches as slave switches;
providing a user interface in said master switch to communicate with said master switch;
communicating with said slave switches through said master switch; and
controlling said slave switches through said master switch.

17. The method as recited in claim 16, wherein one of configuring said slave switches, retrieving status data of said slave switches, and retrieving statistical data of said slave switches is performed in said controlling step.

18. A method for managing a stack of switches, comprising the steps of:
constructing said stack of switches according to a predetermined topology;
recording said topology in each of said switches;
identifying one of said switches as a master switch and others of said switches as slave switches; and
controlling said slave switches through said master switch.

19. The method as recited in claim 18, wherein one of said slave switches is used as a master switch in case that said master switch does not work.
